(19) United States
(12) Patent Application Publication
(10) Pub. No.: US 2009/0160296 A1
(43) Pub. Date: Jun. 25, 2009

(54) Polyphase Electric Machine

(76) Inventors: Stefan Steinbock, Urspringen (DE); Ingolf Groening, Lohr am Main (DE); Christian Kaehler, Partenstein (DE)

Correspondence Address: KENYON & KENYON LLP, ONE BROADWAY, NEW YORK, NY, 10004, US

(21) Appl. No.: 11/886,609

(22) PCT Filed: Mar. 2, 2006
(86) PCT No.: PCT/EP2006/001877

§ 371 Date: Dec. 19, 2008

(30) Foreign Application Priority Data
Mar. 16, 2005 (DE) 10 2005 012 503.4
Jul. 7, 2005 (DE) 10 2005 032 122.4

(51) Int. Cl. H02K 7/10; H02K 21/22

(52) U.S. Cl. 310/75 R; 310/156.01

(57) ABSTRACT

A polyphase electric machine includes a stator impinged by an electromagnetic rotating field, which has a yoke having yoke teeth having at least partially peripheral slots, in which windings generating a magnetic field are situated, and having a rotor rotatable around an axis having permanent magnets, which is peripherally separated from the stator by an air gap, the rotor being fixedly connected to a pulley, the yoke teeth in the stator being assembled into modules, whose number is equal to the current phases or corresponds to their integral multiple, each module including a number of at least one yoke tooth and—in the event of a possible pole pitch of the rotor to slot pitch of the stator ratio of 9/8—yoke teeth of a module directly neighboring one another having opposite magnetic field polarity. Using this system, an electric drive having a particularly flat construction, in particular for an elevator drive, may be implemented, which has increased force density and simultaneously significantly reduced torque ripple.

### FIELD OF THE INVENTION

The present invention relates to a polyphase electric machine having a stator impinged by an electromagnetic rotating field, the rotor having a yoke with yoke teeth having at least partially peripheral slots, in which windings generating a magnetic field are situated, and having a rotor, which is rotatable around an axis, having permanent magnets, the rotor being peripherally separated from the stator by an air gap and fixedly connected to a pulley.

### BACKGROUND INFORMATION

Polyphase electric machines of this type are used in greatly varying drive concepts. Such electric motors having flat constructions are often used in elevator drives in particular.

An electric motor of this type is described, for example, in European Published Patent Application No. 1 394 096. The publication describes an electric motor which is designed as a flat, disk-shaped drive for an elevator, the rotor being connected in one piece to a pulley, implemented as a roller, for driving cables and/or belts. The rotor is designed as a flat wheel rim and has permanent magnets on the outside. The housing of the electric motor, which forms the stator, is shaped such that it substantially encloses the rotor on one side. A yoke having windings is situated on the peripheral wall on the interior of the housing, diametrically opposite the permanent magnets of the rotor. It is to be emphasized that in this embodiment the pulley has a smaller diameter than the diameter of the rotor. This makes a drive having particularly strong torque possible. Components such as a rotational angle encoder and an electrical brake may be situated inside the rotor, without projecting beyond the external contour of the drive machine.

A driving pulley elevator is described in European Published Patent Application No. 0 779 233, which includes a propulsion pulley which works together with the elevator cables and whose diameter is also less than the diameter of the stator or the rotor.

Ideally, an electric motor for drives of this type is to provide a constant torque at every instant. Only then is the cabin conveyed smoothly and may sudden tensions in the elevator cables be avoided. The torque ripple is a measure of how much the torque of the polyphase machine deviates from the mean torque on the motor at an instant. The torque ripple is usually specified in relation to the mean torque of the electric motor as a function of the rotor angle. If a motor has too high a torque ripple, it is no longer possible to reach a desired rotor position exactly. Furthermore, an electric motor is to have a low leakage inductance and is not to have a high saturation behavior. A low leakage inductance may be implemented in particular by the largest possible spacing of the yoke teeth in the stator. This therefore results from the electric loading behavior being a function of the motor geometry and the configuration of the coils. A low saturation behavior of the motor results from a low leakage inductance, which in turn opens up a high maximum speed and thus a broad area of application in regard to the speed for the motor.

To reduce the torque ripple of a synchronous motor, European Published Patent Application No. 1 315 274 describes a stator whose yoke teeth or tooth modules (multiple directly neighboring yoke teeth) are wound around using coils such that directly neighboring elements have different magnetic field polarities when current flows through them, the number of the yoke teeth or the number of the modules being precisely double the number of current phases used for the motor. This motor has the disadvantage of its high saturation behavior.

Furthermore, it is disadvantageous that in conventional electric motors, the scalability of the power/torque is only possible via an enlargement of the diameter, as is described in PCT International Published Patent Application No. WO 98/32684, for example.

### SUMMARY

Example embodiments of the present invention provide a polyphase electric machine which allows a flat, space-saving construction in particular for use in elevator drives in elevator shafts having a small cross section and has a low torque ripple at high force density.

According to example embodiments of the present invention, the yoke teeth in the stator are combined into modules, whose number is equal to that of the current phases or corresponds to its integral multiple, each module including a number of at least one yoke tooth and—in the event of a possibly provided ratio of pole pitch of the rotor to slot pitch of the stator of 9/8—yoke teeth of a module directly neighboring one another having an opposing magnetic field polarity. A large number of direction changes of the magnetic field around the circumference of the polyphase machine is achieved by this construction, which reduces the torque ripple.

The magnetic field in the air gap may be implemented in the radial direction to the axis, whereby bearings are only loaded with radial forces. Axial forces on the bearings are thus largely avoided.

If the rotor of the polyphase electric machine is implemented as an external rotor, relatively compact drives having a high torque and—if needed—high speed may thus be implemented.

A particularly space-saving example embodiment is achieved if the stator has a peripheral recess, in which the windings having a core assembly and the permanent magnets having a rotor yoke of the rotor are accommodated.

In a further example embodiment, it may be provided that the windings in directly neighboring yoke teeth of two modules are implemented in the same rotational direction. In this configuration, harmonics are obtained in the rotating fields, which only find a congruent harmonic of a magnetic field of the rotor at a high harmonic number, and thus at a low amplitude, which significantly reduces the torque oscillations of the polyphase machine.

If the yoke teeth have pole shoes, which at least partially close the slots lying between the yoke teeth on the side of the air gap, a substantially sinusoidal curve of the induced voltage results, which reduces the leakage inductance.

Particularly high magnetic force fields may be achieved if the yoke has auxiliary yoke teeth between two directly neighboring yoke teeth. These teeth increase the torque in base load operation because more iron is available for guiding the flux and thus the individual windings have a shorter flux path available via iron, which is known to have a greater permeability (μᵣ) than air.

In an example embodiment, the ratio of a pole pitch of the rotor to a slot pitch of the stator is 9/10 or 9/8, 6/5 or 6/7 or 3/4, each module including at least 3 yoke teeth at the pole pitch to slot pitch ratio of 9/10 or 9/8, at least two yoke teeth at the pole pitch to slot pitch ratio of 6/5 or 6/7, and at least one yoke tooth at the pole pitch to slot pitch ratio of 3/4. In these specific embodiments, equal numbers of magnetic poles are opposite in each case on the rotor and stator, because of the double poles arising due to the phase position of the supply voltage and the winding direction of the windings, and thus a uniform torque curve is achieved.

If a winding embodiment
a −a −a a a −a b −b −b b b −b c −c −c c c −c
   is selected at the pole pitch of the rotor to the slot pitch of the stator ratio of 9/8 and a winding embodiment
a −a −a a a −a −b b b −b −b b c −c −c c c −c
   is selected at the pole pitch of the rotor to the slot pitch of the stator ratio of 9/10, a, b, and c representing the current phases of the three-phase current, a particularly uniform torque curve may be achieved.

If the rotor of the polyphase electric machine has a recess to at least partially accommodate a bearing, additional bearings may be installed compared to known drive concepts or the distances may be enlarged in the case of two bearings, which reduces the load on the bearings or distributes it more uniformly, without increasing the width of the system.

A particularly flat construction may be achieved if the rotor has a recess to distance the rotor from the yoke and from the windings and to attach the yoke to the stator.

In regard to a further reduction of the overall depth of the polyphase electric machine, it may be provided that the stator has a recess to distance the stator from the fasteners of the pulley on the rotor.

An encoder may be situated on the polyphase machine to transmit the current rotor position to the controller.

A projection may be situated on a circular path concentric to the pulley or the counter-pulley, whose radius is larger than the radius of the pulley. This prevents a cable or a belt from being able to slip off of the pulley. This type of securing may be performed either for the pulley or for the counter-pulley or for both pulleys simultaneously using one or more projections.

If the polyphase electric machine is implemented such that the stator is at least partially enclosed by a motor housing side, e.g., the mounting side (motor rear side), i.e., the side which is also used to fasten the motor to a support, and is at least partially enclosed by the rotor, an example embodiment having an especially easily accessible interior may be implemented. The reason for this is that the drive-side components rotor/stator are situated at the rear and the pulleys are situated at the front. The stator and the rotor do not have to be dismounted to reach the pulleys. The drive-side components remain untouched when mechanical components which are situated in front of the drive-side components are changed.

The motor housing may include a removable cover; the motor interior may thus be easily protected from external influences and remains accessible. For this purpose, as already indicated above, the housing rear side enclosing the rotor is designed such that it is simultaneously used to fasten the entire system to a support, the cover being situated on the diametrically opposite housing side. If the housing rear side is mounted on the wall of an elevator shaft, for example, a fitter may obtain access to the motor interior, in particular to the pulleys, during maintenance work or assembly work at any time by removing the front-side, i.e., shaft-side, cover.

It may be provided in regard to cost-effective manufacturing that the rotor is constructed from multiple identical rings.

If a polyphase electric machine described above is used for driving an elevator, drive concepts having particularly flat constructions may thus be implemented, using which one or more cables and/or belts may be driven, which provides advantages in particular in elevator shafts having a small cross section. In particular in connection with the force field orientation described above and the special configuration of windings, scalable, high-torque elevator drives simultaneously having low torque ripple may thus be implemented. The same advantages also apply for escalator drives.

A method for assembling/disassembling a force transmission means, in particular a cable or a belt, in a polyphase electric machine includes a first step, in which the cover is removed, a second step, in which the force transmission means is removed/attached, and a third step, in which the cover is re-placed.

Example embodiments of the present invention are explained in greater detail in the following on the basis of the exemplary embodiments illustrated in the figures.

### BRIEF DESCRIPTION OF THE DRAWINGS

FIG. 1 shows a polyphase electric machine for an elevator drive in a sectional illustration;

FIG. 2 shows a schematic illustration of a yoke in a front view;

FIG. 3 shows a schematic illustration of a yoke having yoke auxiliary teeth in a front view;

FIG. 4 shows a schematic illustration of a rotor;

FIG. 5 shows a time curve of voltage and magnetic field on a stator;

FIG. 6 shows a further polyphase electric machine for a drive in a sectional illustration;

FIG. 7 shows a front view of an elevator drive according to FIG. 6.

### DETAILED DESCRIPTION

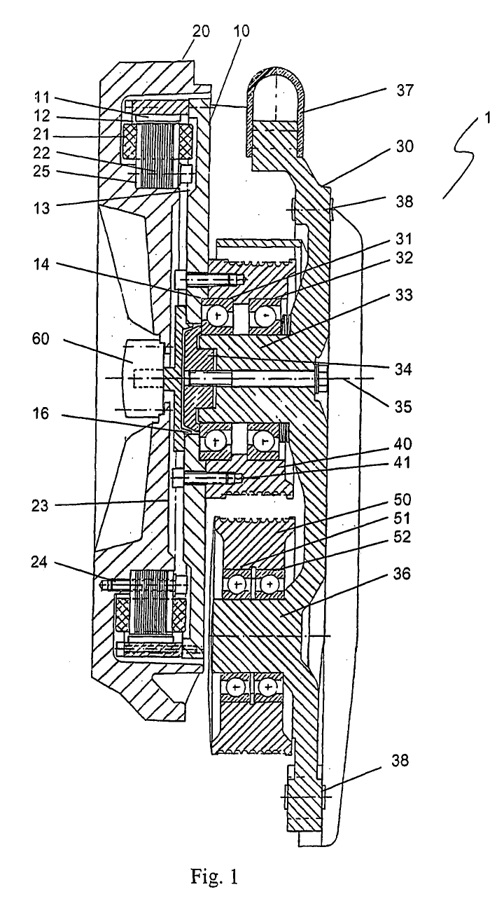

FIG. 1 shows a sectional illustration of a polyphase electric machine in a design according to an example embodiment of the present invention, as it is used in particular in space-saving elevator drives.

As its modules, the polyphase electric machine has a rotor 10 and a stator 20, which are connected via a shared axis 35 to a housing 30, shaped as a half-shell, which is used for suspension and therefore has a transport eye 37. The motor is mounted, i.e., suspended, by fastening holes 38, through which the motor is screwed onto a support or onto the shaft wall of the elevator.

Housing 30 is designed as bearing pins 33 around axis 35 and carries a pulley 40 for driving cables and/or belts, which is mounted so it is easily rotatable on bearing pins 33 using bearings 31, 32 designed as ball bearings. A buttress 34, which is situated in the area of a central bearing opening 16 of rotor 10 and is held on housing 30 using an axial screw, is used for securing on the axis.

In this illustration, the disk-shaped area of rotor 10 has a peripheral grooved recess 14 in the area of axis 35, which at least partially accommodates bearing 31. The spacing of bearings 31, 32 may therefore be enlarged on bearing pins 33.

The possibility also exists of lengthening pulley 40 axially, so that bearings 31, 32 only have contact with pulley 40. Rotor 10 then has a somewhat larger bearing opening 16, but remains fixed on pulley 40.

In the example embodiment shown, housing 30 has a further bearing pin 36, on which a second pulley 50 is mounted so it is freely rotatable using further bearings 51, 52. This pulley is used to reduce the bearing load according to the block-and-tackle principle.

Pulley 40 is connected rigidly to rotor 10 using multiple fasteners 41 situated peripherally at equal angular intervals, which are designed in the example shown as screw connections. Rotor 10 is designed as a disk and may be constructed from multiple identical rings. Permanent magnets 11 are situated on the circumference of rotor 10 perpendicular to the disk plane, and are spaced apart from a yoke 22 having windings 21 via a peripheral air gap 12. Yoke 22 is fixed to stator 20 using multiple fasteners 24 situated peripherally at equal angular intervals.

In the example embodiment shown, stator 20 has a peripheral, stepped recess 25, in which windings 21 of yoke 20 and, in a peripheral gap which is formed, rotating permanent magnets 11 of rotor 10 are accommodated. This allows a particularly space-saving configuration and helps to reduce the overall depth.

To reduce the overall depth further, stator 20 has a recess 23 for spacing stator 20 apart from fasteners 41 of pulley 40 on rotor 10.

In the example embodiment shown, a rotational angle encoder 60 is situated centrally on the stator, which indicates the precise position and/or the velocity (tachometer) via an analysis unit. This encoder may be situated externally on the stator, as shown in the example, or also internally, for example, in the area of buttress 34.

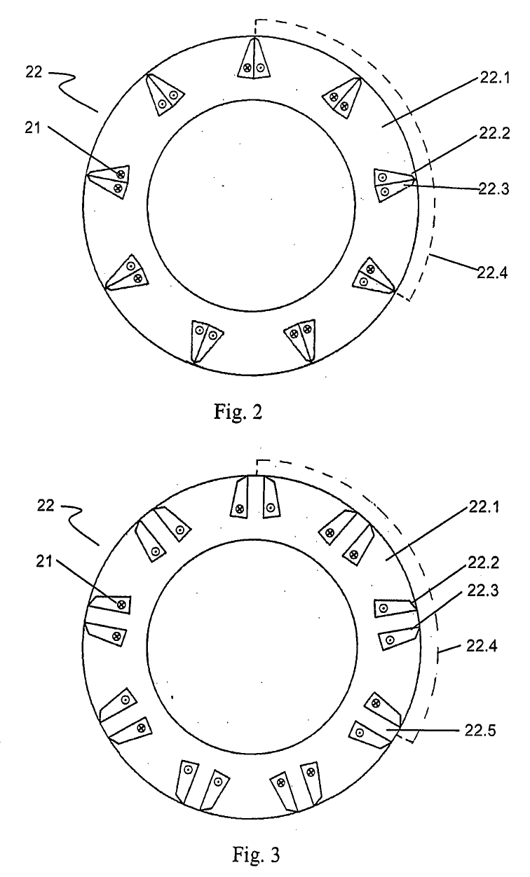

The configuration of windings 21 in the area of yoke 22 is decisive for the torque and the torque ripple. This is schematically shown in FIG. 2.

FIG. 2 shows a front view of yoke 22. In the example shown, it has nine yoke teeth 22.1, which point radially outward at equal angular intervals. Yoke 22 is typically constructed from multiple thin, one-piece ferromagnetic steel plates (stator plates) to minimize eddy current losses. The free ends of yoke teeth 22.1 form a circle as the external contour of yoke 22, around which permanent magnets 11 of rotor 10 rotate, separated by air gap 12. In the exemplary embodiment shown, yoke teeth 22.1 have pole shoes 22.2 on their ends, which at least partially close the remaining gaps between two directly neighboring yoke teeth 22.1 at the free ends. Other embodiments do not have pole shoes 22.2.

A peripheral slot 22.3 is provided around each yoke tooth 22.1, windings 21 being provided in each of these peripheral slots 22.3, which each generate a magnetic field that varies over time during the operation of the motor. The winding direction is identified as a point coming out of the plane of the drawing or as a cross pointing into the plane of the drawing. Three directly neighboring yoke teeth 22.1 form a module 22.4 in this example embodiment, stator 20 of polyphase electric machine 1 having three modules 22.4, which each include three yoke teeth 22.1, in this example embodiment. In other embodiments, however, more than three modules 22.4 may be provided per stator 20 or also each module 22.4 may have more than only three yoke teeth 22.1, in the latter case, the number of yoke teeth 22.1 per module 22.4, e.g., being odd.

In an example embodiment, windings 21 in directly neighboring yoke teeth 22.1 of two modules 22.4 may be implemented in the same rotational direction.

FIG. 3 shows a further example embodiment of the present invention, in which, in contrast to the embodiment according to FIG. 2, an auxiliary yoke tooth 22.5 is provided in each case between two directly neighboring yoke teeth 22.1. This example embodiment is advantageous in particular in the range of low current strengths, because more iron is available for flux guiding.

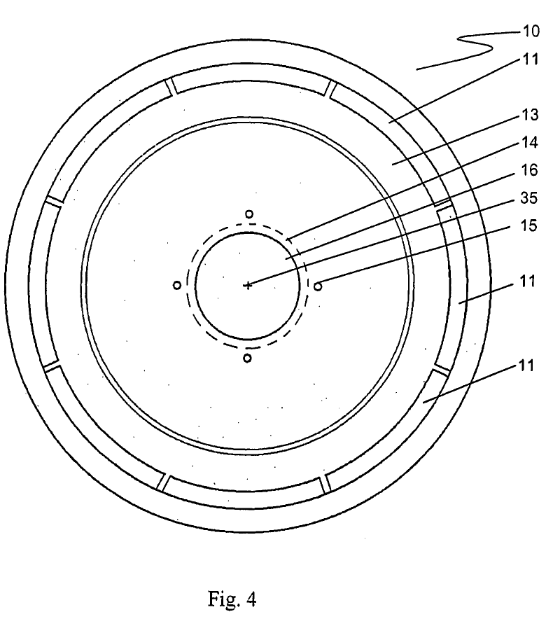

FIG. 4 schematically shows a front view of rotor 10 having eight permanent magnets 11 situated in a collar on the circumference, which each occupy equally large circular arc sections and each alternately have different inwardly directed polarity of the magnetic field. Recess 13, implemented as a peripheral groove, central bearing opening 16, and holes 15 for accommodating fasteners 41 for pulley 40 may also be recognized in this illustration. Recess 14, which is used to at least partially accommodate bearing 31, is shown concealed.

A variable which is decisive for the motor is the ratio of pole pitch τ_{P} of permanent magnets 11 of rotor 10 to slot pitch τ_{N} of yoke 22 of stator 20. In the exemplary embodiment shown, pole pitch τ_{P}=1/8. Slot pitch τ_{P} of yoke 22 in FIG. 2 or FIG. 3, in contrast, is a measure of the space required for a winding 21 situated on the circumference of stator 20, which is situated in a slot 22.3 of a yoke tooth 22.1. Slot pitch τ_{N} shown in these exemplary embodiments is 1/9. Therefore, the ratio of pole pitch τ_{P} of rotor 10 to slot pitch τ_{P} of stator 20 is 9/8. In general, slot pitch τ_{N} is 1/(n×m), m being the number of current phases and n being a whole number. The number of poles is either (n×m)−1 or (n×m)+1. Therefore, for example, ratios of 9/10, 6/5, 6/7, or 3/4 may also be represented if m=3 and n=3, 2, or 1. A number n>2 is particularly preferable, because a lower torque ripple may be assumed here due to the field distribution. At a pole pitch to slot pitch ratio of 6/5 or 6/7, modules 22.4 include at least two yoke teeth 22.1, and at a pole pitch to slot pitch ratio of 3/4, they include at least one yoke tooth 22.1.

In an example embodiment, a winding embodiment
a −a −a a a −a b −b −b b b −b c −c −c c c −c
   is selected at the pole pitch of rotor 10 to the slot pitch of stator 20 ratio of 9/8 and a winding embodiment
a −a −a a a −a −b b b −b −b b c −c −c c c −c
   is selected at the pole pitch of rotor 10 to the slot pitch of stator 20 ratio of 9/10, a, b, and c representing the current phases of the three-phase current.

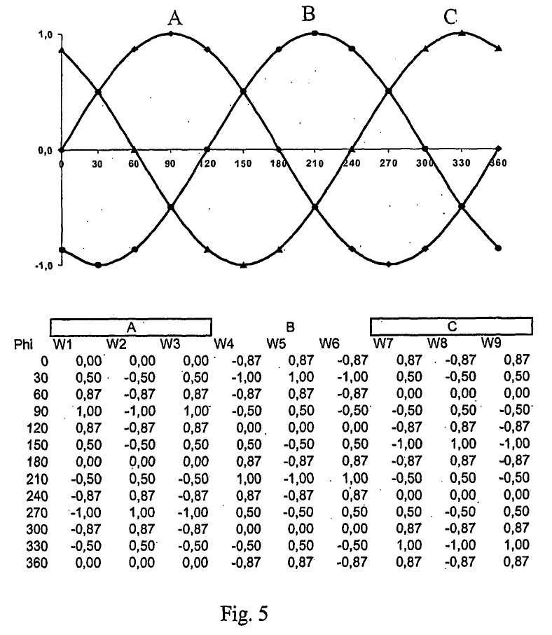

FIG. 5 shows the curve of the electrical voltage at windings 21 on stator 20 and the magnetic field resulting therefrom. The electrical voltages have a sinusoidal curve, voltage A rising from a zero crossing to the maximum value “1,” reaching its negative maximum value “−1” after a further zero crossing, and having the value “0” again at the end of the cycle in the time curve of a phase angle Phi, which runs from 0 to 360° and subsequently repeats. In the example embodiment from FIG. 2 having three modules 22.4, the electrical voltage has three phases A, B, and C, phase B being shifted by 120° in relation to phase A, and phase C in turn being shifted by 120° in relation to B.

In the following, the magnetic fields at windings 21 of modules 22.4 according to FIG. 2 are observed at an instant at which phase Phi is 30°. The results are summarized in the table in FIG. 5. A magnetic north pole is identified by a positive number, a south pole by a negative number. The number 1 (or −1) identifies the maximum occurring field. At phase Phi of 30°, voltage A is positive and generates a north pole in first winding W1 of first module 22.4. Second winding W2 is oriented opposite, as described for FIG. 2, and thus generates an equally strong south pole. Winding W3 has the same orientation as W1 and generates a north pole. Voltage B at winding W4 in the same direction lying next to W3 is maximally negative and W4 thus generates a strong south pole. W5 and W6, lying next to it, generate maximal north poles and south poles. The third module supplied with voltage C generates the sequence of moderate-strength north pole, south pole, north pole. At this instant, neighboring windings W1 and W9 each generate a north pole, so that a double pole occurs at this point and a total of 8 alternating magnetic field poles are distributed around the circumference of yoke 22. The double pole rotates with the time sequence. At phase Phi of 150°, it is located at windings W3 and W4. A thorough observation shows that the double poles each only arise having weak magnetic fields, so that they only result in a slight asymmetry.

In a further example embodiment of polyphase machine 1, the number of yoke teeth 22.1 is an even multiple of 9 yoke teeth, so that magnetic double poles are opposite one another in each case and the asymmetry of the system first described in FIG. 5 is corrected.

An electrical drive having a particularly flat construction may be implemented using the system shown, in particular for an elevator drive, which has an increased force density and simultaneously a significantly reduced torque ripple. Smaller bearing forces arise in the axial direction due to the formation of a radial field, which guarantee a higher bearing service life. This drive concept offers advantages in regard to cost-effective manufacture, because assembly is made easier. Safety aspects also come to bear, because the danger of (finger) engagements is avoided in the assembled state.

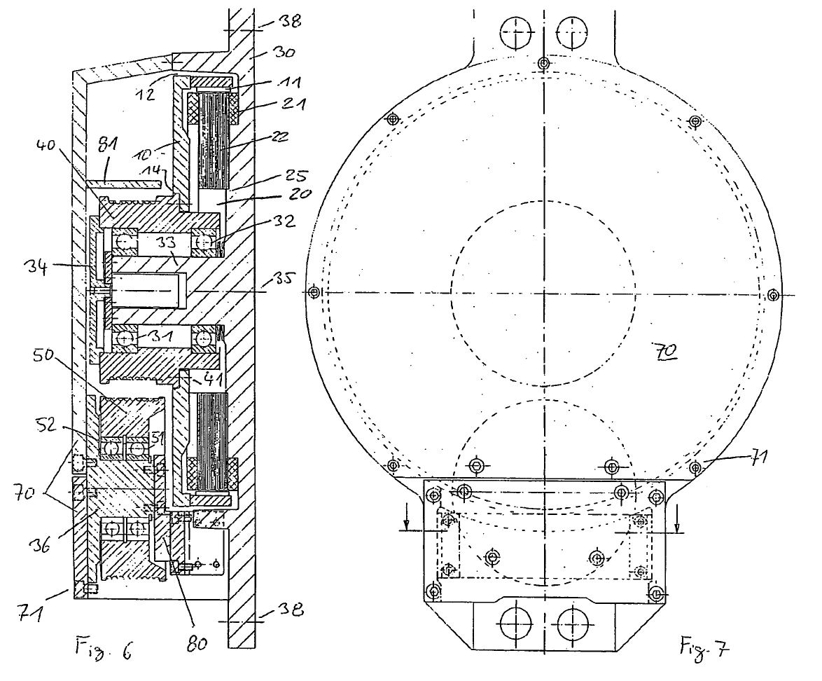

FIG. 6 shows an example embodiment of the present invention from FIG. 1 as a sectional illustration of a polyphase electric machine in a design according to the present invention, as may be used in particular in elevator drives or escalator drives having a flat construction.

This polyphase electric machine also has a rotor 10 and a stator 20 as its essential modules. The motor is mounted, i.e., suspended, using fastening holes 38, using which the motor may be screwed onto a support.

Housing 30 is designed as bearing pins 33 around axis 35 and supports a pulley 40 for driving cables and/or belts, which is mounted in such a way that it is easily rotatable on bearing pins 33 using bearings 31, 32 designed as ball bearings. A buttress 34 is used for securing on the shaft.

In this illustration, the disk-shaped area of rotor 10 has a peripheral grooved recess 14 in the area of pulley 40, which at least partially accommodates the pulley.

In the example embodiment shown, the system has a further bearing pin 36, on which a second pulley 50 is mounted so it is freely rotatable using further bearings 51, 52. This pulley is used to reduce the bearing loads according to the block-and-tackle principle.

Pulley 40 is connected rigidly to rotor 10 using multiple fasteners 41 situated peripherally at equal angular intervals. Rotor 10 is implemented as a disk and may be constructed from multiple identical rings. Permanent magnets 11, which are spaced apart from a yoke 22 having windings 21 via a peripheral air gap 12, are situated on the circumference of rotor 10 perpendicular to the disk plane. Yoke 22 is secured to stator 20 or housing 30 using multiple fasteners situated peripherally at equal angular intervals.

In the example embodiment shown, stator 20 is integrated in support-side housing 30, in contrast to the example embodiment shown in FIG. 1, and also has a peripheral, stepped recess 25, in which windings 21 of yoke 22 and, in a peripheral gap which is formed, rotating permanent magnets 11 of rotor 10 are accommodated. This allows a particularly space-saving configuration and helps to reduce the overall depth.

Because of its position, stud bolt 81 prevents the cable from being able to slip off of pulley 40. Such a stud bolt would also be conceivable on counter roll 50.

The entire system is closed using a front cover 70. Cover 70 may be implemented in one piece or multiple pieces and is also used for securing counter-pulley 50.

A rotational angle encoder may be situated centrally in the example embodiment shown, which provides the precise position and/or the velocity (tachometer) via an analysis unit.

The configuration of windings 21 in the area of yoke 22 is decisive for the torque and the torque ripple. This configuration is schematically shown in FIG. 2.

Thus, in contrast to the device shown in FIG. 1, this example embodiment places stator 20 and rotor 10 closer to the direction of the support, using which the entire configuration is screwed onto an elevator shaft wall, for example.

The advantage of the configuration shown here is that pulley/counter-pulley 40/50 are immediately accessible after removal of cover disk(s) 70. Counter-pulley 50 is connected to the housing a component 80, which secures counter-pulley 50 in the axial and vertical directions. In addition, cover part 70 locks the axis of counter-pulley 50, so that higher rigidity of the configuration is achieved. The arrangement of all housing parts ensures secure and contact-free guiding of the cable.

The replacement of the endless cable is very simple because of the configuration shown here. The procedure is described briefly in the following.

First, the tension must be taken from the cable or drive belt using suitable measures. No more noteworthy forces then act on pulley 40 and/or counter-pulley 50 because of the cable tension. Front housing cover 70, i.e., directed in the direction of the elevator shaft, for example, is removed by loosening corresponding screw connections 71. Both pulleys 40 and 50 are freely accessible after removing cover 70 and the cable may be inserted or removed. Cover 70 is then mounted again and the cable is again tensioned. It is not necessary to reorient motor components such as motor brakes, stator, and rotor in relation to one another. This is an advantage which saves time and therefore costs in particular during initial assembly and maintenance work.

The shaft-side frontal view of the drive may be seen in FIG. 7, in particular cover 70 having screws 71, which would be loosened in case of maintenance work.

1-22. (canceled)

23. A polyphase electric machine, comprising:
a stator, impinged by an electromagnetic rotating field, including a yoke having yoke teeth having at least partially peripheral slots, in which windings, which generate a magnetic field, are situated; and
a rotor, which is rotatable around an axis, having permanent magnets, which is peripherally separated from the stator by an air gap, the rotor fixedly connected to a pulley;
wherein the yoke teeth in the stator are assembled into modules, whose number is at least one of (a) equal to a number of current phases and (b) corresponds to an integral multiple thereof, each module including a number of at least one yoke tooth and directly neighboring yoke teeth of a module having opposing magnetic field polarity.

24. The polyphase electric machine according to claim 23, wherein a ratio of a pole pitch of the rotor to a slot pitch of the stator is 9/8.

25. The polyphase electric machine according to claim 23, wherein the magnetic field in the air gap is formed in the radial direction to the axis.

26. The polyphase electric machine according to claim 23, wherein the rotor is arranged as an external rotor.

27. The polyphase electric machine according to claim 23, wherein the stator has a peripheral recess, in which the windings including a core assembly and the permanent magnets including the rotor yoke of the rotor are arranged.

28. The polyphase electric machine according to claim 23, wherein the windings in directly neighboring yoke teeth of two modules are arranged in a same rotational direction.

29. The polyphase electric machine according to claim 23, wherein the yoke teeth have pole shoes, which at least partially close the slots lying between the yoke teeth on a side of the air gap.

30. The polyphase electric machine according to claim 23, wherein the yoke has yoke auxiliary teeth between two directly neighboring yoke teeth.

31. The polyphase electric machine according to claim 23, wherein a ratio of the pole pitch of the rotor to the slot pitch of the stator is one of: (a) 9/10; (b) 9/8; (c) 6/5; (d) 6/7; and (e) 3/4; each module including at least 3 yoke teeth at the pole pitch to slot pitch ratio of one of (a) 9/10; and (b) 9/8; at least two yoke teeth at the pole pitch to slot pitch ratio of one of (a) 6/5; and (b) 6/7; and at least one yoke tooth at the pole pitch to slot pitch ratio of 3/4.

32. The polyphase electric machine according to claim 31, wherein a winding arrangement:
a −a −a a a −a b −b −b b b −b c −c −c c c −c
is provided at the pole pitch of the rotor to slot pitch of the stator ratio of 9/8 and a winding arrangement:
a −a −a a a −a −b b b −b −b b c −c −c c c −c
is provided at the pole pitch of the rotor to the slot pitch of the stator ratio of 9/10;
wherein a, b, and c represent current phases of a three-phase current.

33. The polyphase electric machine according to claim 23, wherein the rotor has a recess to at least partially accommodate a bearing.

34. The polyphase electric machine according to claim 23, wherein the rotor has a recess for spacing apart the rotor from the yoke and the windings and a fastener of the yoke on the stator.

35. The polyphase electric machine according to claim 23, wherein the stator has a recess for spacing apart the stator from fasteners of the pulley on the rotor.

36. The polyphase electric machine according to claim 23, wherein the rotor is constructed from multiple identical rings.

37. The polyphase electric machine according to claim 23, wherein an encoder is situated on the polyphase electric machine.

38. The polyphase electric machine according to claim 23, wherein a projection is situated on a circular path concentric to the pulley, whose radius is larger than a radius of the pulley.

39. The polyphase electric machine according to claim 23, wherein the stator is at least partially enclosed by a motor housing and the rotor.

40. The polyphase electric machine according to claim 23, wherein a cover is situated on a motor housing.

41. The polyphase electric machine according to claim 23, wherein the polyphase electric machine is configured as a drive for at least one of (a) a freight elevator and (b) a passenger elevator.

42. The polyphase electric machine according to claim 23, wherein the polyphase electric machine is configured as at least one of (a) a cable drive and (b) a belt drive having at least one pulley.

43. The polyphase electric machine according to claim 23, wherein the polyphase electric machine is configured a drive for an escalator.

44. A device, comprising:
a polyphase electric machine including:
a stator, impinged by an electromagnetic rotating field, including a yoke having yoke teeth having at least partially peripheral slots, in which windings, which generate a magnetic field, are situated; and
a rotor, which is rotatable around an axis, having permanent magnets, which is peripherally separated from the stator by an air gap, the rotor fixedly connected to a pulley;
wherein the yoke teeth in the stator are assembled into modules, whose number is at least one of (a) equal to a number of current phases and (b) corresponds to an integral multiple thereof, each module including a number of at least one yoke tooth and directly neighboring yoke teeth of a module having opposing magnetic field polarity; and
wherein the device is arranged as at least one of (a) a passenger elevator; (b) a freight elevator; and (c) an escalator.

45. A method for at least one of (a) assembling and (b) disassembling a force transmission device in a polyphase electric machine including: a stator, impinged by an electromagnetic rotating field, including a yoke having yoke teeth having at least partially peripheral slots, in which windings, which generate a magnetic field, are situated; a rotor, which is rotatable around an axis, having permanent magnets, which is peripherally separated from the stator by an air gap, the rotor fixedly connected to a pulley; and a cover situated on a motor housing, the yoke teeth in the stator being assembled into modules, whose number is at least one of (a) equal to a number of current phases and (b) corresponds to an integral multiple thereof, each module including a number of at least one yoke tooth and directly neighboring yoke teeth of a module having opposing magnetic field polarity, comprising:
removing the cover;
at least one of (a) removing and (b) attaching the force transmission device; and
refastening the cover.

46. The method according to claim 45, wherein the force transmission device includes at least one of (a) a cable and (b) a belt.
